(19) United States
(12) Patent Application Publication
(10) Pub. No.: US 2024/0082865 A1
(43) Pub. Date: Mar. 14, 2024

(54) MASK FORMING SYSTEM FOR PROTECTING A STRUCTURE AND A METHOD OF FORMING A MASK FOR THE SAME

(71) Applicant: The Boeing Company, Arlington, VA (US)

(72) Inventors: Guerin Thomas Hollingsworth, Summerville, SC (US); Bryce Kenneth Hoch, Ravenel, SC (US); Robert Frederick Rivers, Jr., Summerville, SC (US); Michael Saul Zelinsky, Daniel Island, SC (US); Shelly J. Collinson, Goldbar, WA (US); Benjamin David Haygood, Summerville, SC (US); Jason Anson Dill, Stanwood, WA (US)

(73) Assignee: The Boeing Company, Arlington, VA (US)

(21) Appl. No.: 18/461,456

(22) Filed: Sep. 5, 2023

Related U.S. Application Data
(60) Provisional application No. 63/405,205, filed on Sep. 9, 2022.

(51) Int. Cl. B05B 12/24; B05D 1/32

(52) U.S. Cl. CPC B05B 12/24; B05D 1/325

(57) ABSTRACT

A mask forming system for protecting a structure and a method of forming a mask for protecting the structure includes a masking material having a first layer, a second layer, and a third layer sandwiched together. The masking material is unrolled across a platform and a plurality of features are generated in the masking material, wherein the features include printing, kiss cutting, and double-kiss cutting the masking material. Data is printed on the first layer of the masking material. The first layer of the masking material is kiss cut. The second layer of the masking material is double-kiss cut. The third layer remains uncut and unprinted on during the formation of the mask. The masking material remains in the same orientation during printing and kiss cutting of the first layer, and the masking material remains in the same orientation during double-kiss cutting of the second layer.

### CROSS-REFERENCE TO RELATED APPLICATIONS

This application claims the benefit of U.S. Provisional Application No. 63/405,205, filed on Sep. 9, 2022, which is hereby incorporated by reference in its entirety.

### BACKGROUND

In manufacturing an aircraft, various types of coatings may be applied to different structures of the aircraft. For example, the coatings may include at least one or more of a sealant, an adhesive, a primer, an optical coating, a corrosive-resistant coating, lacquer, paint, other suitable types of coatings, etc.

The coatings may provide the structures with desired characteristics for the performance of the aircraft. As an example, the aircraft may include a plurality of skin panels that cooperate with each other to form a fuselage of the aircraft, and the skin panels/the fuselage may be painted.

A sprayer may be used to apply the paint to the structures of the aircraft. In this situation, it is desirable to minimize overspray of the paint onto other structures of the aircraft. Therefore, in some situations, a protective material may be placed over the structures prior to painting to protect the structures from unintended contact with the paint, such as overspray. The protective material may include a masking material that is secured to the surface of the structures such that movement of the masking material is reduced during painting.

However, creating and applying the masking material may take more time than is desired. In addition, the masking material may not protect the structure as desired, and overspray may need to be removed. As a result, manufacturing of the aircraft may take more time than desired.

Furthermore, to create the protective material, a flat-bed table may be used, which is large in size, and the protective material is flipped over on the flat-bed table and flipped back during the process. Therefore, the flat-bed has a large footprint in the manufacturing facility, and the process to create the protective material is time consuming because there are a number of touch labor points, which includes flipping over the protective material.

### SUMMARY

Therefore, it is desirable to develop a method and a system of forming a mask that minimizes overspray and reduces application time, as well as possibly other issues. Furthermore, it is desirable to develop a method and a system that reduces the footprint in the manufacturing facility.

As such, the present disclosure provides a method of forming a mask for protecting a structure. A masking material is unrolled across a platform. The platform supports the masking material during formation of the mask. The masking material includes a first layer, a second layer, and a third layer sandwiched together. A plurality of features are generated in the masking material. The features include printing, kiss cutting, and double-kiss cutting the masking material. Generating the features includes printing data on the first layer of the masking material, kiss cutting the first layer of the masking material, and double-kiss cutting the second layer of the masking material. The third layer remains uncut and unprinted on during the formation of the mask. The masking material remains in the same orientation during printing and kiss cutting of the first layer, and the masking material remains in the same orientation during double-kiss cutting of the second layer.

In addition, the present disclosure provides a mask forming system for protecting a structure. The mask forming system includes a platform. A masking material is disposed over the platform, and the masking material is disposed in a rolled form before being disposed over the platform. The masking material includes a first layer facing outwardly away from the platform. The first layer is configured to receive markings and one or more kiss cuttings. The masking material includes a second layer disposed between the first layer and the platform. The second layer is configured to receive one or more double-kiss cuttings. The masking material includes a third layer disposed between the second layer and the platform such that the third layer abuts the platform. The third layer is configured to remain unaltered when the masking material is disposed on the platform.

The detailed description and the drawings or FIGS. are supportive and descriptive of the disclosure, but the claim scope of the disclosure is defined solely by the claims. While some of the best modes and other configurations for carrying out the claims have been described in detail, various alternative designs and configurations exist for practicing the disclosure defined in the appended claims.

### BRIEF DESCRIPTION OF THE DRAWINGS

FIG. 1 is a schematic illustration of an aircraft that may use a mask formed via a mask forming system described herein.

FIG. 2 is a schematic illustration of the mask forming system.

FIG. 2A is a schematic enlarged fragmented illustration of a masking material having a plurality of layers taken from line 2A of FIG. 2.

FIG. 3 is a schematic enlarged fragmented illustration of the masking material of FIGS. 2 and 2A.

FIG. 4 is another schematic illustration of the masking material having the layers.

FIG. 5 is a schematic illustration of the masking material having the layers and indicating which of the layers is printed on and which of the layers is cut.

FIG. 6 is a schematic exploded front side illustration of the layers of the masking material with printing and cutting on the respective layers.

FIG. 7 is a schematic exploded back side illustration of the layers of the masking material of FIG. 6 illustrating the printing and the cutting on the respective layers from the other side.

The present disclosure may be extended to modifications and alternative forms, with representative configurations shown by way of example in the drawings and described in detail below. Inventive aspects of the disclosure are not limited to the disclosed configurations. Rather, the present disclosure is intended to cover modifications, equivalents, combinations, and alternatives falling within the scope of the disclosure as defined by the appended claims.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims. Moreover, terms such as “first,” “second,” “third,” and so on, may be used to describe separate components. Such terminology may include the words specifically mentioned above, derivatives thereof, and words of similar import. Furthermore, the term “substantially” can refer to a slight imprecision or slight variance of a condition, quantity, value, or dimension, etc., some of which that are within manufacturing variance or tolerance ranges.

As used herein, an element or step recited in the singular and preceded by the word “a” or “an” should be understood as not necessarily excluding the plural of the elements or steps. Further, any reference to “one configuration” is not intended to be interpreted as excluding the existence of additional configurations that also incorporate the recited features. Moreover, unless explicitly stated to the contrary, configurations “comprising” or “having” an element or a plurality of elements having a particular property may include additional elements not having that property. The phrase “at least one of” as used herein should be construed to include the non-exclusive logical “or”, i.e., A and/or B and so on depending on the number of components.

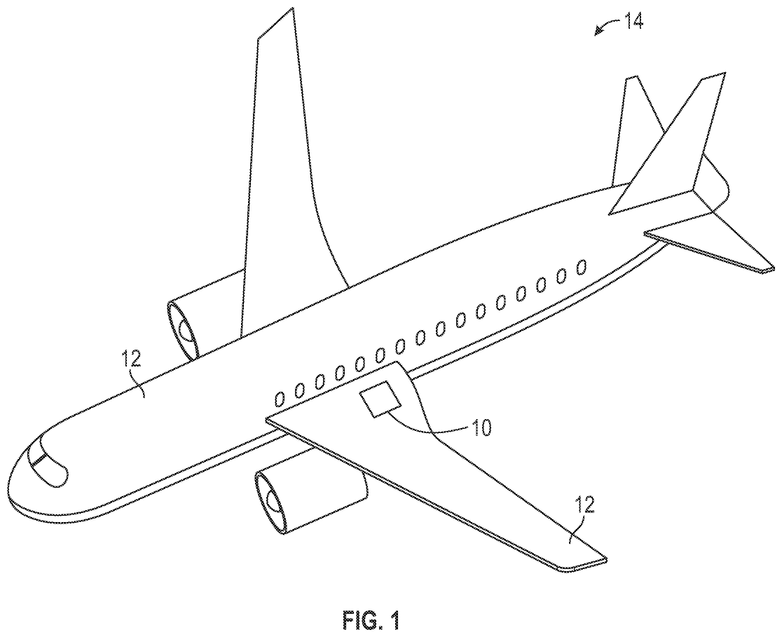

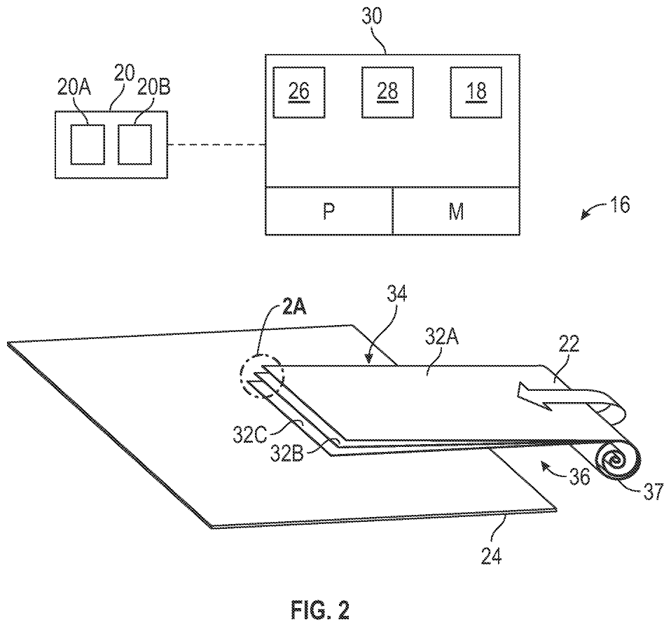

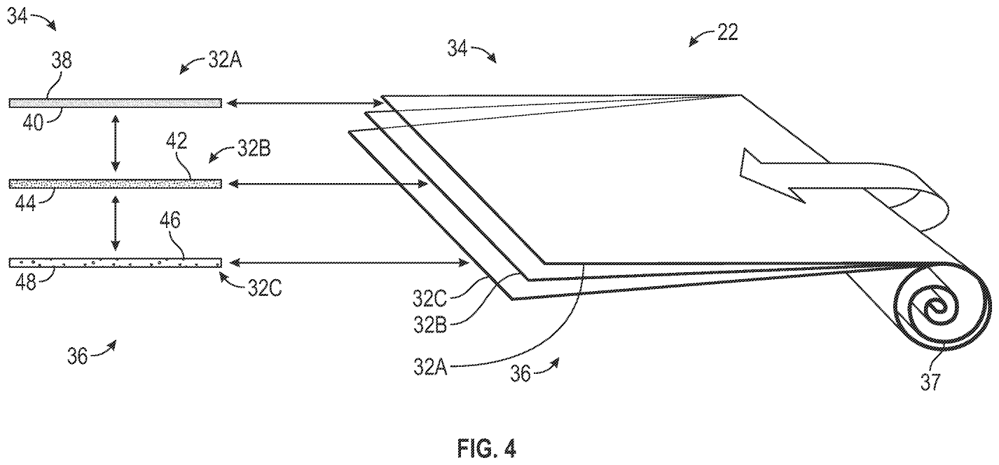

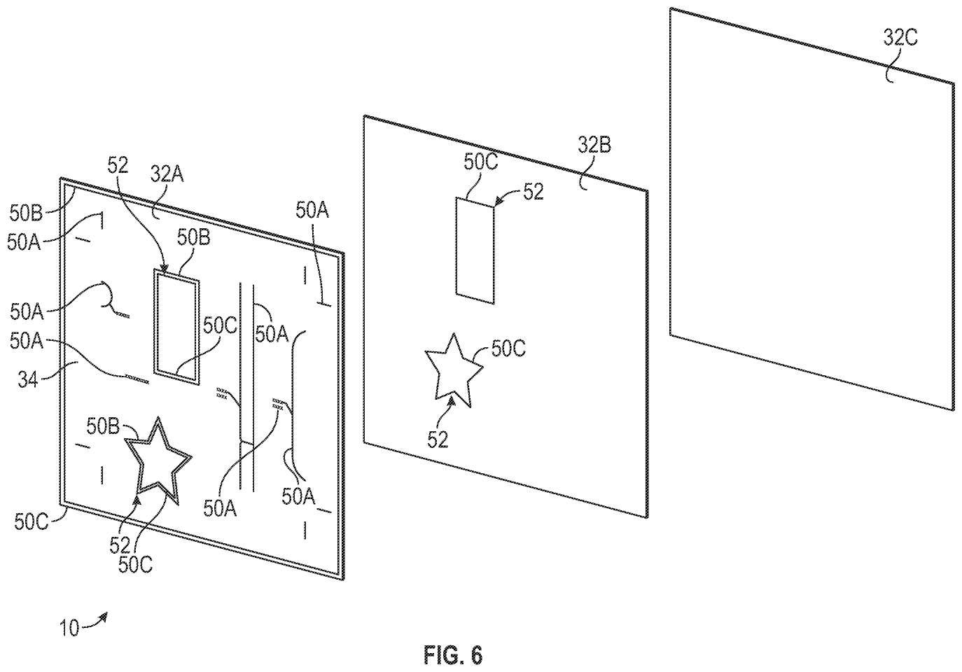

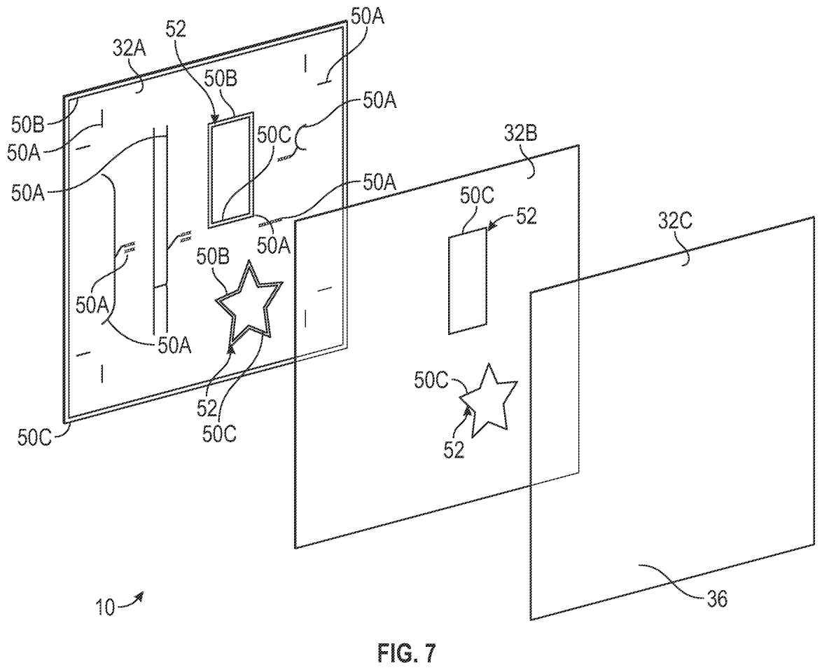

The illustrative configurations contemplate one or more different considerations. For example, the illustrative configurations contemplate that it may be desirable to have a protective material, such as a mask 10 (see FIGS. 6 and 7), for protecting one or more surfaces 12 of one or more structures 14 (see FIG. 1). Referring to the figures, wherein like numerals indicate like or corresponding parts throughout the several views, the protective material, such as the mask 10, may be used in a mask forming system 16 (see FIGS. 2-7) and a method to protect one or more of the surfaces 12 of one or more of the structures 14.

The mask forming system 16 may include one or more of the masks 10. For example, the illustrative configurations contemplate that the mask forming system 16 includes the mask 10 having the shape of the surface 12 of the respective structures 14 to increase a level of protection from overspray of paint or other applications of coating material during manufacturing. The term overspray may refer to the application of a material, such as paint, onto a location beyond what is desired. In other words, overspray may refer to the application of the material, such as paint, in an unintended location.

It may be desirable to reduce the amount of time to form and apply the mask 10 to the structure 14. For example, it may be desirable to form the mask 10 that includes an adhesive, such that application of the mask 10 onto the surface 12 of the respective structures 14 may be completed in a single operation. Moreover, the illustrative configurations contemplate that it may be desirable to manufacture more than one mask 10 in the mask forming system 16 at the same time.

Thus, the illustrative configurations may provide the method, the system 16 and an assembly for protecting the structure, and in certain configurations, protecting a plurality of structures 14. The surface 12 of the structure 14 may be identified from a model 18 of the structure 14. In certain configurations, a two-dimensional representation of the mask forming system 16 may be generated for the structure 14 based on the perimeter of the surface 12 of the structure 14. Features 50A-50C for the mask forming system 16 may be generated within the two-dimensional representation. Identifiers may be assigned to the features 50A-50C in the two-dimensional representation. Instructions to control a forming tool 20 may be generated based on the identifiers. The mask forming system 16 may be formed from a sheet of a masking material 22 using the forming tool 20 based on the instructions.

The structures 14 may be any suitable configuration, and non-limiting examples of the structures 14 may include movable platforms such as vehicles, payloads, drones, space shuttles, aircrafts, components inside of the aircraft, components outside of the aircraft, carts, etc. and/or non-movable platforms such as buildings, equipment, etc. The aircraft may include a plurality of the structures 14. The structures 14 may be physical parts or objects that form the aircraft. The structures 14 may take various forms, and for example, the structures 14 may include a member, a skin panel, a door, a door seal, a window, a barrel, a fuselage section, a wingbox, a reservoir, a kick plate, a forward edge of a kick plate, an aft edge of a kick plate, a vent, a seal, a door vent seal, a control surface, a fastener system, a door handle, a hinge, a compartment, a static port, a light, a cargo vent, a cover plate, and other suitable types of structures 14.

The below discussion will refer to one of the structures 14, as the structure 14, but the below discussion applies to any number of surfaces 12 and any number of structures 14. The structure 14 may have one or more surfaces 12, and therefore, one or more masks 10 may be applied to one or more surfaces 12 of the structure 14. The surfaces 12 may be the uppermost layer of structure 14. In other words, the surfaces 12 of the structure 14 may be exposed to the environment. Therefore, for example, when the structure 14 is a window, the surfaces 12 may include one of surfaces 12 that faces outside of the aircraft (i.e., exposed to the environment outside of the aircraft) and another one of the surfaces 12 that faces inside of the aircraft (i.e., exposed to the environment inside of the aircraft). In another illustrative example, when the structure 14 is a door handle, the structure 14 may include more than one of the surfaces 12 that face outside of the aircraft (i.e., exposed to the environment outside of the aircraft).

A perimeter of the surface 12 of the structure 14 may be identified, in which it is desirable to create the mask 10 for that surface 12. Therefore, the surface 12 of the structure 14 may have the perimeter. The perimeter may be identified as the surface 12 of the structure 14 to be covered by the mask forming system 16 during painting of the structure 14. That is, the perimeter may represent an outer boundary of the surface 12 of the structure 14. Therefore, for example, when the structure 14 is a window, the perimeter may be the outer boundary of the window. As another example, when the structure 14 is a door, the perimeter may be the outer boundary of the door.

It may be desirable to protect the surface 12 of the structure 14 as paint is applied to the aircraft. In other words, the surface 12 may be a portion of the aircraft in which the paint is not to be applied. The mask forming system 16 may include a three-dimensional structure that is used to cover the surface 12 of the structure, and thus, protect the surface 12 during painting of the aircraft. The mask forming system 16 may include one, single, mask 10 or include a plurality of masks 10. By applying or using the mask 10, there may be a reduction of paint contacting undesirable locations of the structure 14. The perimeter of the surface 12 may represent the outer boundary of the surface 12 that the mask 10 covers when attached to the structure 14.

Referring to FIG. 2, the mask forming system 16 may include the mask 10, the forming tool 20, a platform 24, a database 26, a computer-aided design software 28, and a controller 30. The controller 30 is in communication with the computer-aided design software 28 and the database 26. The controller 30 may also be in communication with the forming tool 20. The controller 30 is configured to execute the instructions from a memory M, via a processor P to select the model 18 and control the forming tool 20 to create or form the mask 10 per the specification of the model 18 and/or the computer-aided design software 28.

For example, the controller 30 may be a host machine or distributed system, e.g., a computer such as a digital computer or microcomputer, and, as the memory M, tangible, non-transitory computer-readable memory such as read-only memory (ROM) or flash memory. The controller 30 may also have random access memory (RAM), electrically erasable programmable read-only memory (EEPROM), a high-speed clock, analog-to-digital (A/D) and/or digital-to-analog (D/A) circuitry, and any required input/output circuitry and associated devices, as well as any required signal conditioning and/or signal buffering circuitry. Therefore, the controller 30 may include all software, hardware, memory M, algorithms, connections, sensors, etc., necessary to control, for example, the forming tool 20, and/or the computer-aided design software 28. As such, a control method operative to control the forming tool 20 and/or form the mask 10, may be embodied as software or firmware associated with the controller 30. Optionally, more than one controller 30 may be utilized, more than one database 26 may be utilized, more than one computer-aided design software 28 may be utilized, and more than one forming tool 20 may be utilized.

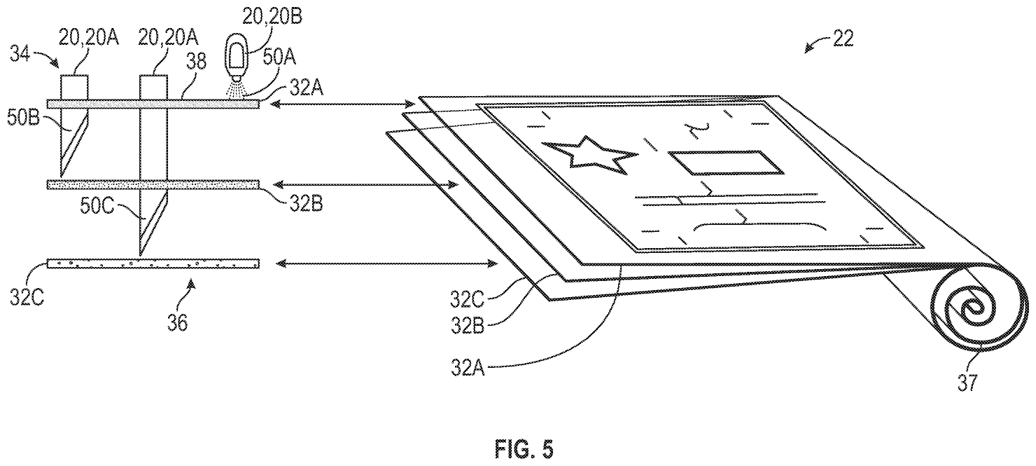

The platform 24 and the forming tool 20 are used to perform various operations to form the mask 10. For example, the platform 24 may include a table or any other platform 24 to support the forming tool 20 and/or support the masking material 22 (see FIG. 2). Turning to FIG. 5, the forming tool 20 may include a cutting device 20A such as a blade, a cutter, a laser, or any other tools to cut the masking material 22 to form the mask 10. In addition, the forming tool 20 may include an applicator 20B to apply ink or any other suitable marking medium to mark the masking material 22.

The database 26 is used to store and retrieve one or more models 18 of the structures 14, and more specifically, the surfaces 12 of the structures 14. The database 26 may contain files of locations and configurations of predefined process paths, which contain location information about printing 50A and cutting 50B, 50C. The controller 30 may retrieve this information from the database 26 that contains files about the locations and the configurations of predefined process paths.

The computer-aided design software 28 may be configured to retrieve the model 18 of the structure 14 from the database 26. From the model 18, the computer-aided design software 28 may then identify the surface 12 and the perimeter of the surface 12 of the structure 14 to be covered by the mask 10. Therefore, the controller 30 and the computer-aided design software 28 may cooperate with each other to control the forming tool 20 based on the chosen model 18.

The computer-aided design software 28 may include a computer program implemented within a computer system. For example, the computer system may include one or more computers, and if utilizing more than one of the computers, the computers are in communication with each other via a communications medium such as a network. The computer-aided design software 28 may be selected from various types of software. For example, the computer-aided design software 28 includes one or more of AutoCAD, Autodesk, CATIA, Pro/Engineer, SolidWorks, Unigraphics, or any other suitable types of computer-aided design software 28.

Generally, the method, the assembly, and the system described herein provides a way of producing or forming the mask 10 for masking the structure 14, such as a composite component of the aircraft, prior to painting.

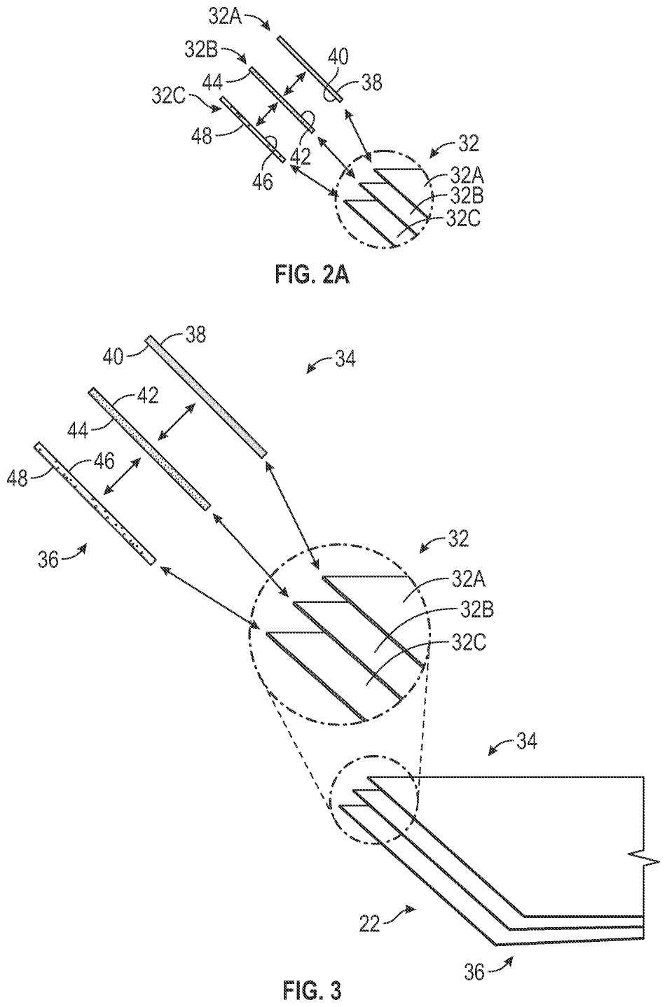

Turning to FIGS. 2A and 3, the masking material 22 includes a plurality of layers 32 or sheets that are stacked on top of each other to ultimately form the mask 10. When the mask 10 is complete, one of the layers 32 form a top side 34 of the mask 10 and a bottom side 36 of the mask 10. In this configuration, one of the layers 32 forms the top side 34 of the mask 10 and a different one of the layers 32 form the bottom side 36 of the mask 10.

The layers 32 of the masking material 22 are webbed together to create a master roll 37 of material that is used to form the mask 10 (see FIGS. 2, 4, and 5 illustrating the roll 37). That is, the master roll 37 of material is rolled, which creates a space savings. That is, the roll 37 of masking material 22 takes up less space in a manufacturing facility, and thus, leaves a smaller footprint as compared to the footprint of the design discussed in the background section above.

Generally, each of the layers 32 of the masking material 22 is formed of a translucent material. That is, the masking material 22 permits light to pass through the layers 32, which may cause the opposite side to be visible either clearly or not clearly. Each of the layers 32 in FIGS. 2A and 3-5 are illustrated with different speckling to visually distinguish the different layers 32 for ease of discussion, and this speckling is not to be construed as more.

In certain configurations, the masking material 22 includes a first layer 32A, a second layer 32B, and a third layer 32C sandwiched together. The first layer 32A, the second layer 32B, and the third layer 32C are formed of the translucent material. The first layer 32A, the second layer 32B, and the third layer 32C in FIGS. 2A and 3-5 are illustrated with different speckling to visually distinguish the different layers 32A-32C for ease of discussion, and this speckling is not to be construed as more.

The first layer 32A may be the top layer of the mask 10, which also includes the top side 34 of the mask 10. The first layer 32A may include a printable surface 38 and a release surface 40 opposing the printable surface 38. The release surface 40 of the first layer 32A faces the second layer 32B, and in certain configuration, the release surface 40 abuts the second layer 32B. The release surface 40 may be a glossy surface configured to release from the second layer 32B. Therefore, the release surface 40 may also be referred to as a release liner, and in certain configurations, the first layer 32A may be defined as the release liner.

The printable surface 38 may also be the top side 34 of the mask 10. The printable surface 38 is configured to receive markings, indicia, graphics, symbols, text, etc., hereinafter referred to as data or printing 50A. Therefore, the printable surface 38 may receive ink, scribing, etching, or other marking medium. The printable surface 38 may be treated with a coating, or any other suitable treatment, to accept ink or other marking medium.

In certain configurations, printing 50A the data occurs only on the first layer 32A. The data is visible from the first layer 32A (top layer) and the third layer 32C (bottom layer) due to each of the layers 32 being the translucent material. FIG. 6 illustrates the top layer showing the printed data, and FIG. 7 illustrates the bottom layer in which the printed data of the top layer is visible through the bottom layer.

Data printed on the printable surface 38 of the first layer 32A is printed in the reverse so that the data is orientated properly when the mask 10 is applied to the structure 14 of the aircraft. That is, the data is printed in reverse on the printable surface 38 so that the data reads properly from the opposite side, because the opposite side is applied to the structure 14 of the aircraft. Therefore, printing 50A the data on the first layer 32A includes printing 50A the data in a reverse orientation that is visible through the first layer 32A, the second layer 32B, and the third layer 32C (the data illustrated in FIGS. 5 and 6 is shown in the reverse orientation). Said differently, the data printed on the printable surface 38 is inverted to create a mirror image. That is, the mirror-image of, for example, the location markings, is printed on the printable surface 38 of the first layer 32A, i.e., the release liner.

The mask 10 is then placed on the surface 12 of the structure 14 by abutting the first layer 32A to the surface 12 of the structure 14 such that the data is reversed back to a proper orientation on the structure 14. That is, the top side 34 of the first layer 32A abuts the surface 12 of the structure 14 to apply the mask 10 to the surface 12, which causes the data to be reversed back to the proper orientation. FIG. 7 illustrates the data reversed back to the proper orientation and the orientation that the mask 10 is applied to the structure 14.

The second layer 32B may be the middle layer of the mask 10, and thus, between the top layer and the bottom layer. That is, the second layer 32B is disposed between the first layer 32A and the third layer 32C. The second layer 32B may include a first adhesive layer 42 and a vinyl surface 44 opposing the first adhesive layer 42. The first adhesive layer 42 faces the release surface 40 of the first layer 32A, and the vinyl surface 44 faces the third layer 32C. In certain configurations, the first adhesive layer 42 of the second layer 32B abuts the release surface 40 of the first layer 32A. The first adhesive layer 42 may also be configured of a translucent adhesive. That is, the translucent adhesive permits light to pass therethrough, which allows the opposite side to be visible either clearly or not clearly. The second layer 32B may be defined as a vinyl material layer.

The third layer 32C may be the bottom layer of the mask 10, which also includes the bottom side 36 of the mask 10. The third layer 32C may be configured as a transfer medium for the second layer 32B. The third layer 32C may include a second adhesive layer 46 and a transfer surface 48 opposing the second adhesive layer 46. The second adhesive layer 46 faces the vinyl surface 44, and the transfer surface 48 may also be the bottom side 36 of the mask 10. In certain configurations, the second adhesive layer 46 of the third layer 32C abuts the vinyl surface 44 of the second layer 32B. The second adhesive layer 46 may also be configured of a translucent adhesive. That is, the translucent adhesive permits light to pass therethrough, which allows the opposite side to be visible either clearly or not clearly. In certain configurations, the third layer 32C may be defined as transfer tape.

The first layer 32A, the second layer 32B, and the third layer 32C are sandwiched together to form the masking material 22, which will ultimately form the mask 10. Therefore, the first adhesive layer 42 and the second adhesive layer 46 adhere the first layer 32A, the second layer 32B, and the third layer 32C together. The masking material 22 is stored in the roll 37, and thus, the roll 37 takes up less floor space in the manufacturing facility. The roll 37 may be one continuous sheet of the masking material 22 that is rolled around itself. Using the roll 37 also provides faster throughput speeds and eliminates a number of touch points because the masking material 22 is not flipped over to form the mask 10 as compared to design discussed in the background section above.

When it is desirable to form one or more of the masks 10, the masking material 22 is unrolled across the platform 24. Therefore, the roll 37 of the masking material 22 may be stored adjacent to the platform 24 or at any other suitable location and then accessed when desired. When unrolling the masking material 22, the top layer faces outwardly away from the platform 24 and the bottom layer abuts the platform 24 during formation of the mask 10. Therefore, the printable surface 38 of the first layer 32A, or release liner, faces the proper direction (upwardly away from the platform 24) when unrolled, and accordingly, the transfer surface 48 of the third layer 32C, or bottom layer, faces the proper direction (downwardly toward the platform 24) when unrolled.

Optionally, the masking material 22 may be secured to the platform 24 during formation of the mask 10. Once the masking material 22 is placed in the desired orientation across the platform 24, the masking material 22 remains in this orientation until the formation of the mask 10 is complete.

The mask 10 may have one or more features 50A-50C configured to aid in attaching the mask 10 to the surface 12 of the structure 14, identifying the mask 10, designating a particular shape for the mask 10, convey text or symbols etc., or a combination thereof. For example, the features 50A-50C may include one or more of printing data 50A, one or more kiss cuts 50B and one or more double-kiss cuts 50C, and combinations thereof. However, since the mask 10 is configured of at least three layers 32, the third layer 32C or bottom layer is not cut, i.e., the masking material 22 will not have a die cut. Said differently, a die cut severs or penetrates all of the layers, and therefore, the masking material 22 described herein will not have a die cut that severs or penetrates all of the layers 32.

Therefore, generally, the features 50A-50C are generated in the masking material 22. As discussed above, the features 50A-50C may include printing 50A, kiss cutting 50B, and double-kiss cutting 50C of the masking material 22. The forming tool 20 is controlled to generate the features 50A-50C in the first layer 32A and the second layer 32B. The forming tool 20 may be controlled via the controller 30 and/or the computer-aided design software 28. Certain layers 32 may be configured with certain features 50A-50C, as discussed below.

For example, referring to FIG. 5, generating the features 50A-50C may include printing data 50A on the first layer 32A of the masking material 22 and/or kiss cutting 50B the first layer 32A of the masking material 22. In addition, generating the features 50A-50C may include double-kiss cutting 50C the second layer 32B of the masking material 22. Furthermore, the third layer 32C remains uncut and unprinted on during the formation of the mask 10. And, as mentioned above, the masking material 22 remains in the same orientation during printing 50A and kiss cutting 50B of the first layer 32A, and the masking material 22 remains in the same orientation during double-kiss cutting 50C of the second layer 32B. That is, the masking material 22 remains in the same orientation during the generation of all of the features 50A-50C. FIG. 5 illustrates the first layer 32A, the second layer 32B and the third layer 32C spaced from each other for visually illustrating the features 50A-50C relative to the layers 32A-32C, and therefore, it is to be appreciated that performance of the actual process, the layers 32A-32C are sandwiched together, and the features 50A-50C will be applied to the appropriate layers 32A-32C.

Referring to FIG. 5, the kiss cut 50B severs or penetrates the first layer 32A of the mask 10. That is, the kiss cut 50B does not sever or penetrate the second layer 32B. Furthermore, in certain configurations, printing data 50A occurs only on the first layer 32A, and/or the kiss cutting 50B occurs only on the first layer 32A. Therefore, in certain configurations, the top layer is the only layer 32 that is printed on, and the top layer is the only layer 32 that has the kiss cut 50B.

Continuing with FIG. 5, the double-kiss cutting 50C occurs on the second layer 32B. The double-kiss cut 50C severs or penetrates the first layer 32A and the second layer 32B. That is, the first layer 32A and the second layer 32B may be double-kiss cut 50C. Furthermore, the double-kiss cut 50C does not sever or penetrate the third layer 32C. Therefore, the first layer 32A may include printing or data 50A, as discussed above, as well as one or more of the kiss cut 50B and may also be penetrated to perform the double-kiss cut 50C on the second layer 32B. Turning back to the second layer 32B, the second layer 32B may include the double-kiss cut 50C, but does not include printing or data 50A, and does not include the kiss cut 50B.

Cutting of the first layer 32A and the second layer 32B is also performed in a reverse orientation (the kiss cuts 50B and the double-kiss cuts 50C illustrated in FIG. 5 are shown in the reverse orientation). Said differently, cutting of the first layer 32A and the second layer 32B is inverted to create a mirror image. Therefore, all printing 50A and cutting are performed in the reverse orientation so that when the mask 10 is then placed on the surface 12 of the structure 14 by abutting the first layer 32A to the surface 12 of the structure, all printing 50A and cuttings 50B, 50C are reversed back to a proper orientation on the structure 14. FIG. 7 illustrates the printing 50A and the cuttings 50B, 50C reversed back to the proper orientation and the orientation that the mask 10 is applied to the structure 14.

Next turning to the third layer 32C, the third layer 32C does not have any of the features 50A-50C discussed above, and therefore, the third layer 32C does not include printing or data 50A, does not include the kiss cut 50B, and does not include the double-kiss cut 50C. Said differently, the bottom layer does not get cut or printed on.

In summary, the masking material 22 remains in the same orientation to form the features 50A-50C in the mask 10. That is, printing 50A, kiss cutting 50B, and double-kiss cutting 50C occur relative to the top layer facing outwardly away from the platform 24. Furthermore, printing 50A, kiss cutting 50B, and double-kiss cutting 50C occur by using the forming tool 20 that is movable relative to the platform 24. Therefore, the forming tool 20 may be disposed adjacent to the platform 24, and/or be coupled to the platform 24, to move relative to the masking material 22 to print and cut the various layers 32. Optionally, the forming tool 20 may have various interchangeable heads to perform the printing 50A and/or cutting 50B, 50C processes.

Once all of the printing 50A and/or cutting 50B, 50C processes are complete, the mask 10 is removed from the platform 24. For example, the mask 10 may be removed from the platform 24 by rolling up the mask 10 after generating the features 50A-50C is completed. Since the masking material 22 is a continuous roll 37, the roll 37 may be cut prior to starting the formation of the mask 10 to separate the working masking material 22 from the remainder of the roll 37, or alternatively, after the mask 10 is completed, the mask 10 may be cut from the remainder of the roll 37 at the end of the process.

Then, the mask 10 may be stored, or placed in a kitting location, until it is time to apply the mask 10 to the surface 12 of the structure 14. The mask 10 may be rolled up until it is time to use the mask 10 to protect the surface 12 of the structure 14. When ready, the mask 10 is applied to the surface 12 of the structure 14 by abutting the first layer 32A to the surface 12 of the structure 14. The printing 50A and the cuts 50B, 50C are visible through the third layer 32C, which now faces outwardly from the surface 12 of the structure 14. Optionally, painting may occur while the third layer 32C of the mask 10 is attached to the surface 12 of the structure 14. Once the painting is complete with the third layer 32C of the mask 10 attached to the structure, the third layer 32C is then removed to expose areas 52 formed via the cuts 50B, 50C. Then, painting may proceed again, which will allow paint to enter the exposed areas 52. Once all of the painting is completed, then the mask 10 is removed from the surface 12 of the structure 14.

For example, the method and the assembly described herein is directed to a multi-layered, translucent material stack comprising a translucent adhesive-backed vinyl material, a translucent release liner having a printable outer surface disposed on a top surface of the vinyl, and a translucent transfer tape disposed on a bottom surface of the vinyl, opposite the release liner. The proposed material stack is in a rolled form, such that printable outer surface of the release liner is exposed and facing upward when the material is unrolled.

Therefore, the disclosure herein provides a roll-fed, print and cut technology that has a smaller footprint, faster throughput speeds, and eliminates a number of touch points as compared to the design described in the background section above. Generally, the concept is directed toward manufacturing the mask 10 for painting graphics on the surface 12 of the structure 14. Advantageously, all of the cutting (i.e., kiss cuts, double-kiss cuts) of the first layer 32A and the second layer 32B, and marking on an outer surface of the first layer 32A, i.e., the release liner, eliminate the need to flip the masking material 22 during the process.

While the best modes and other configurations for carrying out the disclosure have been described in detail, those familiar with the art to which this disclosure relates will recognize various alternative designs and configurations for practicing the disclosure within the scope of the appended claims. Furthermore, the configurations shown in the drawings or the characteristics of various configurations mentioned in the present description are not necessarily to be understood as configurations independent of each other. Rather, it is possible that each of the characteristics described in one of the examples of a configuration can be combined with one or a plurality of other desired characteristics from other configurations, resulting in other configurations not described in words or by reference to the drawings. Accordingly, such other configurations fall within the framework of the scope of the appended claims.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The illustrations of the configurations described herein are intended to provide a general understanding of the structure of the various configurations. The illustrations are not intended to serve as a complete description of all of the elements and features of apparatus and systems that utilize the structures or methods described herein. Many other configurations may be apparent to those of skill in the art upon reviewing the disclosure. Other configurations may be utilized and derived from the disclosure, such that structural and logical substitutions and changes may be made without departing from the scope of the disclosure. Accordingly, the disclosure and the figures are to be regarded as illustrative rather than restrictive.

The following Clauses provide some example configurations of the method, the system 16 and an assembly as disclosed herein.

Clause 1: A method of forming a mask for protecting a structure, the method comprising: unrolling a masking material across a platform, wherein the platform supports the masking material during formation of the mask, wherein the masking material includes a first layer, a second layer, and a third layer sandwiched together; generating a plurality of features in the masking material, wherein the features include printing, kiss cutting, and double-kiss cutting the masking material; wherein generating the features includes printing data on the first layer of the masking material; wherein generating the features includes kiss cutting the first layer of the masking material; and wherein generating the features includes double-kiss cutting the second layer of the masking material, wherein the third layer remains uncut and unprinted on during the formation of the mask, and the masking material remains in the same orientation during printing and kiss cutting of the first layer, and the masking material remains in the same orientation during double-kiss cutting of the second layer.

Clause 2: The method as set forth in clause 1 wherein: the first layer includes a printable surface and a release surface opposing the printable surface; the release surface abuts the second layer; the second layer includes a first adhesive layer and a vinyl surface opposing the first adhesive layer, the first adhesive layer of the second layer abuts the release surface of the first layer; the third layer includes a second adhesive layer and a transfer surface opposing the second adhesive layer; and the second adhesive layer of the third layer abuts the vinyl surface of the second layer.

Clause 3: The method as set forth in any one of the preceding clauses wherein: the first layer, the second layer, and the third layer are formed of a translucent material; and the first and second adhesive layers are formed of a translucent adhesive.

Clause 4: The method as set forth in clauses 1 or 2 wherein the first layer, the second layer, and the third layer are formed of a translucent material.

Clause 5: The method as set forth in any one of the preceding clauses: wherein printing the data on the first layer includes printing the data in a reverse orientation that is visible through the first layer, the second layer, and the third layer; and further comprising placing the mask on the surface of the structure by abutting the first layer to the surface of the structure such that the data is reversed back to a proper orientation on the structure.

Clause 6: The method as set forth in any one of the preceding clauses wherein printing data occurs only on the first layer.

Clause 7: The method as set forth in any one of the preceding clauses wherein kiss cutting occurs only on the first layer.

Clause 8: The method as set forth in any one of the preceding clauses wherein double-kiss cutting occurs on the second layer.

Clause 9: The method as set forth in any one of the preceding clauses wherein the first layer is a top layer, the second layer is a middle layer, and the third layer is a bottom layer, and wherein unrolling the masking material includes unrolling the masking material such that the top layer faces outwardly away from the platform and the bottom layer abuts the platform during formation of the mask.

Clause 10: The method as set forth in any one of the preceding clauses wherein printing, kiss cutting, and double-kiss cutting occur relative to the top layer facing outwardly away from the platform.

Clause 11: The method as set forth in any one of the preceding clauses wherein printing, kiss cutting, and double-kiss cutting occur by using a forming tool that is movable relative to the platform.

Clause 12: The method as set forth in any one of the preceding clauses further comprising removing the mask from the platform by rolling up the mask after generating the features is completed.

Clause 13: The method as set forth in any one of the preceding clauses further comprising applying the mask to the surface of the structure by abutting the first layer to the surface of the structure.

Clause 14: The method as set forth in any one of the preceding clauses wherein the first layer is further defined as a release liner, the second layer is further defined as a vinyl material layer, and the third layer is further defined as transfer tape.

Clause 15: The method as set forth in any one of the preceding clauses further comprising: identifying a surface of the structure from a model of the structure; and controlling a forming tool to generate the features in the first layer and the second layer.

Clause 16: A mask forming system for protecting a structure, wherein the mask forming system comprising: a platform and a forming tool cooperating with the platform; a masking material disposed over the platform, wherein the masking material is disposed in a rolled form before being disposed over the platform; wherein the masking material includes a first layer facing outwardly away from the platform, and the first layer is configured to receive markings and one or more kiss cuttings; wherein the masking material includes a second layer disposed between the first layer and the platform, and the second layer is configured to receive one or more double-kiss cuttings; and wherein the masking material includes a third layer disposed between the second layer and the platform such that the third layer abuts the platform, and the third layer is configured to remain unaltered when the masking material is disposed on the platform.

Clause 17: The mask forming system as set forth in clause 16 wherein the first layer, the second layer, and the third layer are formed of a translucent material.

Clause 18: The mask forming system as set forth in clauses 16 or 17 wherein the second layer includes a first adhesive layer sandwiched between the first layer and the second layer, and the third layer includes a second adhesive layer sandwiched between the second layer and the third layer.

Clause 19: The mask forming system as set forth in one of clauses 16-18 further including a forming tool cooperating with the platform and configured to form the markings, the kiss cuttings, and the double-kiss cuttings in the masking material.

What is claimed is:

1. A method of forming a mask for protecting a structure, the method comprising:
unrolling a masking material across a platform, wherein the platform supports the masking material during formation of the mask, wherein the masking material includes a first layer, a second layer, and a third layer sandwiched together;
generating a plurality of features in the masking material, wherein the features include printing, kiss cutting, and double-kiss cutting the masking material;
wherein generating the features includes printing data on the first layer of the masking material;
wherein generating the features includes kiss cutting the first layer of the masking material; and
wherein generating the features includes double-kiss cutting the second layer of the masking material, wherein the third layer remains uncut and unprinted on during the formation of the mask, and the masking material remains in the same orientation during printing and kiss cutting of the first layer, and the masking material remains in the same orientation during double-kiss cutting of the second layer.

2. The method as set forth in claim 1 wherein:
the first layer includes a printable surface and a release surface opposing the printable surface;
the release surface abuts the second layer;
the second layer includes a first adhesive layer and a vinyl surface opposing the first adhesive layer;
the first adhesive layer of the second layer abuts the release surface of the first layer;
the third layer includes a second adhesive layer and a transfer surface opposing the second adhesive layer; and
the second adhesive layer of the third layer abuts the vinyl surface of the second layer.

3. The method as set forth in claim 2 wherein:
the first layer, the second layer, and the third layer are formed of a translucent material; and
the first and second adhesive layers are formed of a translucent adhesive.

4. The method as set forth in claim 1 wherein the first layer, the second layer, and the third layer are formed of a translucent material.

5. The method as set forth in claim 4:
wherein printing the data on the first layer includes printing the data in a reverse orientation that is visible through the first layer, the second layer, and the third layer; and
further comprising placing the mask on the surface of the structure by abutting the first layer to the surface of the structure such that the data is reversed back to a proper orientation on the structure.

6. The method as set forth in claim 1 wherein printing data occurs only on the first layer.

7. The method as set forth in claim 1 wherein kiss cutting occurs only on the first layer.

8. The method as set forth in claim 1 wherein double-kiss cutting occurs on the second layer.

9. The method as set forth in claim 1 wherein the first layer is a top layer, the second layer is a middle layer, and the third layer is a bottom layer, and wherein unrolling the masking material includes unrolling the masking material such that the top layer faces outwardly away from the platform and the bottom layer abuts the platform during formation of the mask.

10. The method as set forth in claim 9 wherein printing, kiss cutting, and double-kiss cutting occur relative to the top layer facing outwardly away from the platform.

11. The method as set forth in claim 9 wherein printing, kiss cutting, and double-kiss cutting occur by using a forming tool that is movable relative to the platform.

12. The method as set forth in claim 1 further comprising removing the mask from the platform by rolling up the mask after generating the features is completed.

13. The method as set forth in claim 1 further comprising applying the mask to the surface of the structure by abutting the first layer to the surface of the structure.

14. The method as set forth in claim 1 wherein the first layer is further defined as a release liner, the second layer is further defined as a vinyl material layer, and the third layer is further defined as transfer tape.

15. The method as set forth in claim 1 further comprising:
identifying a surface of the structure from a model of the structure; and
controlling a forming tool to generate the features in the first layer and the second layer.

16. A mask forming system for protecting a structure, wherein the mask forming system comprising:
a platform and a forming tool cooperating with the platform;
a masking material disposed over the platform, wherein the masking material is disposed in a rolled form before being disposed over the platform;
wherein the masking material includes a first layer facing outwardly away from the platform, and the first layer is configured to receive markings and one or more kiss cuttings;
wherein the masking material includes a second layer disposed between the first layer and the platform, and the second layer is configured to receive one or more double-kiss cuttings; and
wherein the masking material includes a third layer disposed between the second layer and the platform such that the third layer abuts the platform, and the third layer is configured to remain unaltered when the masking material is disposed on the platform.

17. The mask forming system as set forth in claim 16 wherein the first layer, the second layer, and the third layer are formed of a translucent material.

18. The mask forming system as set forth in claim 17 wherein the second layer includes a first adhesive layer sandwiched between the first layer and the second layer, and the third layer includes a second adhesive layer sandwiched between the second layer and the third layer.

19. The mask forming system as set forth in claim 16 further including a forming tool cooperating with the platform and configured to form the markings, the kiss cuttings, and the double-kiss cuttings in the masking material.
